(19) United States
(12) Patent Application Publication
(10) Pub. No.: US 2008/0043769 A1
(43) Pub. Date: Feb. 21, 2008

(54) CLUSTERING SYSTEM AND SYSTEM MANAGEMENT ARCHITECTURE THEREOF

(75) Inventor: TOMONORI HIRAI, Fremont, CA (US)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: TYAN COMPUTER CORPORATION, Taipei (TW)

(21) Appl. No.: 11/734,211

(22) Filed: Apr. 11, 2007

Related U.S. Application Data
(60) Provisional application No. 60/822,540, filed on Aug. 16, 2006.

(51) Int. Cl. H04L 12/56

(52) U.S. Cl. 370/420

(57) ABSTRACT

A system management architecture is provided to manage plural compute nodes in a clustering system. Each of the compute nodes basically includes a BMC (Baseboard Management Controller) for local management. Among the compute nodes, a preset one has its BMC connecting with a management network switch through an extra network interface for clustering/system management. A first network interface, which is usually used to connect with the management network switch for communicating with other compute nodes, is utilized for the BMC of the preset compute node to connect with an external management host. A chipset on the preset compute node also connects with the external management host through a system I/O bus and the first network interface. On the preset compute node a operating system provides Network Address Translation service to allow the external management host to access each of the compute nodes.

### 1. CROSS-REFERENCES TO RELATED APPLICATIONS

This application is a non-provisional application of the U.S. provisional application Ser. No. 60/822,540 to Tomonori Hirai, entitled “System Management for a Small Clustering System” filed on Aug. 16, 2006.

### 2. FIELD OF INVENTION

The present invention relates to system management of a clustering system, and more particularly to a chassis-level system management architecture for a small clustering system configured in a single chassis.

### BACKGROUND

FIG. 1 shows a typical implementation for rack-mount based clustering system. Each of the rack-mount servers 11 is a standalone server with a local management hardware/firmware, such as BMC (Baseboard Management Controller) based module. Such local management hardware includes a small micro processor to monitor and control each of the rack-mount servers 11. Network switch 12 connects with the rack-mount severs 11 and external management host(s) 13. In some cases the network may be divided into “management network(s)” and “data communication network(s)”. The external management host is a standalone computer to performance a whole system-level management and process task scheduling and/or balancing. It is possible that a clustering system is monitored and controlled by multiple external management hosts. To build a clustering system based on the rack-mount type of system needs to make numerous system/network changes. Even clustering is supported on such system, a dedicated system-level central management module will still be essential to manage the whole system.

On the other hand, small clustering system usually does not support chassis-level central management. Only some specific high-end systems have a dedicated chassis-level central management module. Although the compute node in the clustering system can possibly be turned on without the head node being actuated first, the user still has to turn the system on node by node, which means the user will have lots of button to push.

FIG. 2 shows a typical implementation for blade type clustering system. The compute node 23 is also a standalone computer with a local management hardware/firmware for remote management. To implement a dedicated chassis-level central management module 21, the chassis management links 22 is used as a special interface other than a network interface (a data communication network 24 and a network switch 25) for remote management. The external management host 26 may be a standalone computer to manage/control clustering tasks of the whole blade system 20 through the network switches, as well as access system management information through a communication path (standard network interface such as Ethernet) and the central management module. Basically, the chassis-level central management module 21 operates as an independent computer with a service processor (not shown) for chassis-level management to manage the units in the whole chassis as “a single system.”

This type of system requires a dedicated service processor or chassis level central management module as well as a special interface (the chassis management links 22) to access each compute node 23 from the service processor. Therefore, a lot of modules need to be customized to support the special interface. To develop a dedicated service processor and use, an independent OS with low-level device and management applications is too complicated.

### SUMMARY

Accordingly, on a preset compute node the present invention uses the same/common hardware as other compute nodes to implement a special topology of clustering/system management network architecture and provides the function of a chassis-level central management module. The present invention will be a cost-effective system management solution. With this scheme, a small clustering system is able to provide the similar function what a high-end server system has in a chassis.

In an embodiment of the present invention, the present invention provides a clustering system that includes a specific system management architecture for managing its compute nodes. The system management architecture mainly includes: plural BMCs (Baseboard Management Controllers) located on the compute nodes respectively to monitor and control the compute nodes remotely; and a management network switch and plural first network interfaces to provide private network connections between the BMCs of the compute nodes; wherein on a preset one of the compute modes an extra network interface connects with the management network switch instead of the first network interface and the BMC connects with a external management host through the first network interface.

In an embodiment of the present invention, each of the compute node includes a chipset respectively and on the preset one of the compute nodes the chipset connects directly with the first network interface through a system I/O bus, as well as connects indirectly with the first network interface through the BMC. In some cases, on the preset one of the compute nodes the chipset connects the BMC through a KCS (Keyboard Controller Style) interface. Besides, each of the first network interfaces and the extra network interface may include a network interface controller. And on the preset one of the compute nodes the BMC may connect with the network interface controller through a sideband SMBus (System Management Bus).

In an embodiment of the present invention, on the preset one of the compute nodes a operating system may provide Network Address Translation service to allow the external management host to access each of the compute nodes. The system management architecture may further include a data network switch and on each of the compute nodes a second network interface may be provided to connect with the data network switch for applications of MPI (Message Passing Interface) or network storage.

The system management architecture may further include a high-speed network switch to connect with each of the compute nodes and facilitate high bandwidth communication between the compute nodes. An additional network interface controller may be configured on either the high-speed network switch or each of the compute nodes. In certain cases, each of the first network interface and the extra network interface is compatible with IPMI (Intelligent Platform Management Interface) specification.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is an explanatory block diagram showing a typical implementation for rack-mount based clustering system in the prior art.

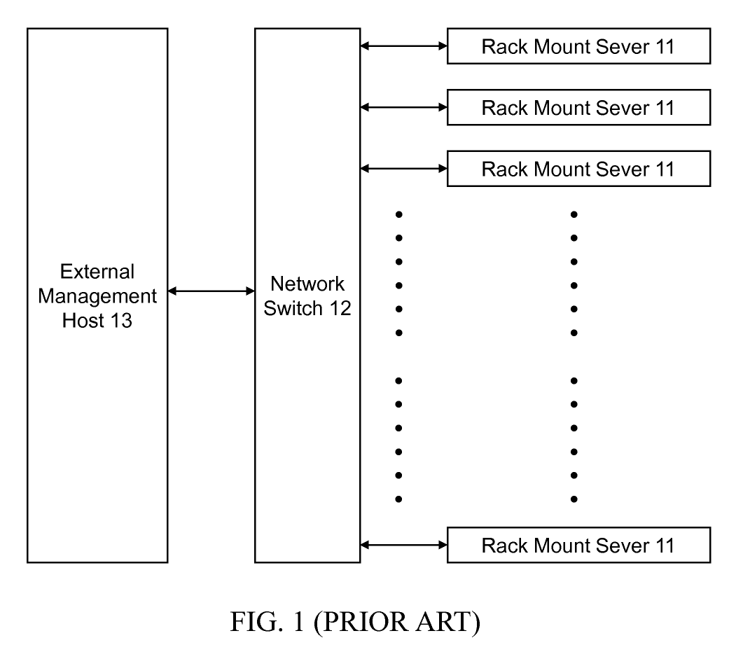

FIG. 2 shows an explanatory block diagram of a typical implementation for blade type clustering system in the prior art.

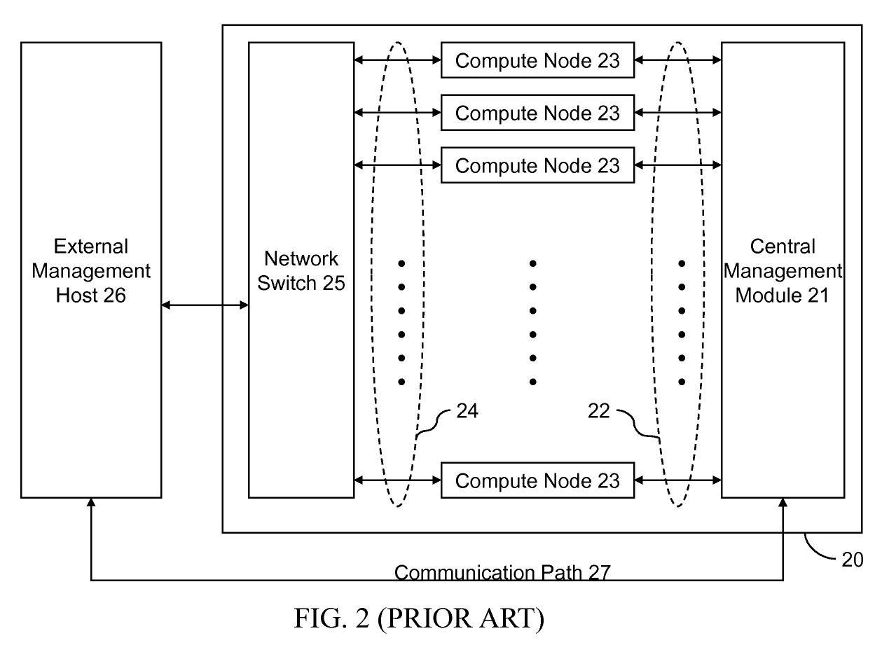

FIG. 3 is an explanatory block diagram of system management architecture for a small clustering system according to an embodiment of the present invention.

FIG. 4 is an explanatory block diagram showing more details for one of applicable designs of the preset compute node according to another embodiment of the present invention.

FIG. 5 is an explanatory block diagram of system management architecture for a small clustering system according to another embodiment of the present invention.

FIG. 6 is an explanatory block diagram showing more details for another of applicable designs of the preset compute node according to another embodiment of the present invention.

FIG. 7 is an explanatory block diagram of system management architecture for a small clustering system according to another embodiment of the present invention.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

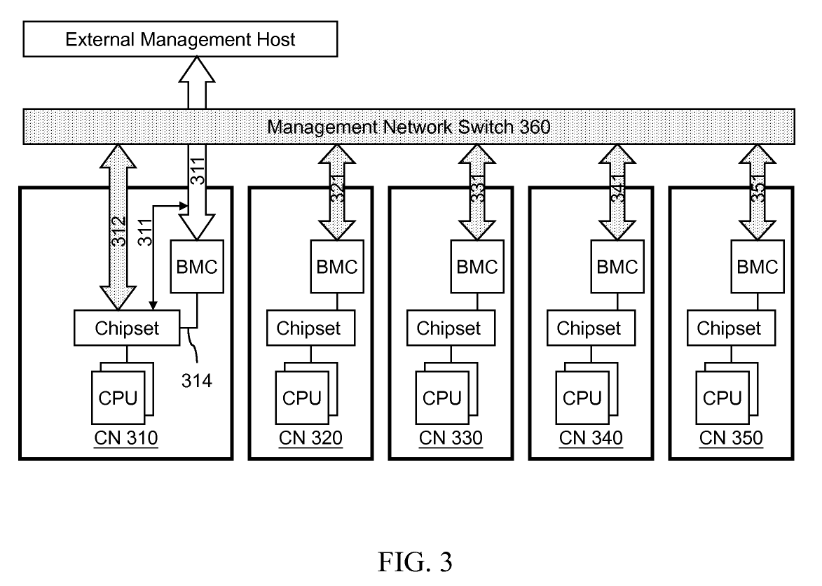

Please refer to FIG. 3, which shows an explanatory block diagram of system management architecture in a small clustering system with plural compute nodes. Basically all the compute nodes in the present invention are almost identical. Only a preset one of the compute nodes has certain changes which applies and reconfigures common hardware. As illustrated in FIG. 3, only a preset compute node CN 310 has some differences from the other compute nodes CN 320, 330, 340, 350.

Each of the computer nodes CN 320, 330, 340, 350 mainly includes two processors CPU, chipset(s) and a BMC (Baseboard Management Controller). A typical implementation for the computer nodes CN 320, 330, 340, 350 is pretty much similar as 1-U type standalone server hardware. The chipset such as South Bridge or other integrated bridge chips connects with the BMC on each of the computer nodes CN 320, 330, 340, 350; and the BMC connects with a corresponding first network interface 321/331/341/351 to provides connections with a management network switch 360 and form private network connections. The management network switch 360 is used mainly for system management as well as clustering management of the clustering system. The BMC collects system management information on each of the computer nodes CN 320, 330, 340, 350 respectively, including operating parameters such as system events, temperature, cooling fan speeds, power mode, operating system (OS) status, etc. and sends alerts to a remote management host. The BMC also executes commands sent from the remote management host to manage the operation of the computer nodes CN 320, 330, 340, 350 respectively. The communication paths between the external management host and each of the BMCs on the compute node CN320/330/340/350 will be further disclosed in the following.

To avoid making fundamental system changes caused by service processor or chassis level central management module in the prior art, only common hardware are added and modified on the preset compute node CN 310. Instead of a first network interface 311, the preset compute node CN 310 includes an extra network interface 312 connecting with the management network switch 360 and the chipset, thereby allows the preset compute node CN 310 to join the private network connections with the management network switch 360 and the other compute nodes CN320, 330, 340, 350. On the other hand, the BMC on the preset compute node CN 310 is used to connect with an external management host through the first network interface 311. Meanwhile, the chipset on the preset compute node CN 310 also connects with the first network interface 311 through a system I/O bus 313 such as PCI or PCI-Express. In other words, on the preset compute nodes CN 310 the chipset connects “directly” with the first network interface 311 through the system I/O bus 313, as well as connects “indirectly” with the first network interface 311 through the BMC. Such design will allow the preset compute node CN 310 to provide the same function as the service controller or the central management module in the prior art.

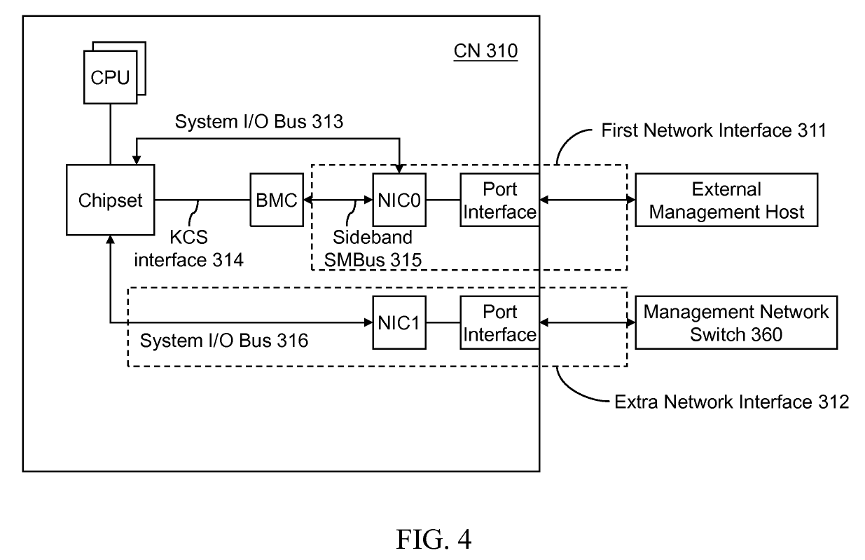

FIG. 4 shows more details for one of applicable designs of the preset compute node according to another embodiment of the present invention. On the preset compute node CN 310 the chipset connects with a network interface controller NIC0 through a system I/O bus 313. The network interface controller NIC0 further connect with the external management host through a port interface and external network links. Another system I/O Bus 316 connects with the chipset and another network interface controller NIC1. The network interface controller NIC1 further connects with the management network switch 360 through another port interface and internal network link (such as network cable). Actually, the first network interface 311 mainly includes the network interface controller NIC0 and the port interface. Similarly, the extra network interface 312 mainly includes the network interface controller NIC1 and another port interface. In some cases, the first network interface 311 and the extra network interface are compatible with IPMI (Intelligent Platform Management Interface) specification as well as the first network interface 321/331/341/351 of the compute node CN 320/330/340/350 in FIG. 3. Besides, the BMC on the preset compute node CN 310 connects with the chipset through a KCS (Keyboard Controller Style) interface 314 and connects with the network interface controller NIC0 through a sideband SMBus (System Management Bus) 315. By means of those modifications, the same function as the service controller or the central management module in the prior art will be provided on the preset compute node CN 310.

First of all, through the first network interface 311 the external management host will be able to access the BMC on the preset compute node CN 310. This BMC collects the system information directly from some sensors configured on the preset compute node CN 310 and collects indirectly from the chipset (through the KCS interface 314) and a hardware monitor controller (not shown). Then, the system information will be sent to the external management host through the BMC, the sideband SMBus 315, the network interface controller NIC0 and the port interface; namely through the BMC and the first network interface 311. Oppositely, the external management host may send direct commands to control the preset compute node CN 310 through the BMC and manage the preset compute node CN 310.

In actual implementation, the preset compute node CN 310 needs to power on first since it has the feature of chassis level management function. To turn it ON, user needs to either use remote power-on scheme (as defined for IPMI based interface), or simply push a physical power button. Once the preset compute node CN 310 is boot-up, an application program called “System Management Software” will be invoked automatically. The system management software may turn on the rest of compute nodes CN 320, 330, 340, 350 in FIG. 3 through the private network connections between all the compute nodes and the management network switch 360. Or, users can use physical buttons to turn on the rest of compute nodes manually.

The System Management Software operating on the preset compute node CN 310 can request the BMCs configured on the rest of other compute nodes CN 320, 330, 340, 350 in FIG. 3 to monitor sensors and send some system event information as a service processor through the private network connections between all the compute nodes and the management network switch 360.

To access individual compute node CN 310/320/330/340/350 from the external management host, an OS (Operating System) operating on the preset compute node CN 310 needs to provide Network Address Translation service. That is, by means of the Network Address Translation service, the external management host will be able to identify the network interface controller NIC0 or NIC1 through which the data is originally sending. Eventually, the external management host can reach the preset compute node CN310 through the first network interface 311 and the BMC, as well as the other compute nodes CN320, 330, 340, 350 through the extra network interface 312, the chipset, the system I/O bus 313 and the first network interface 311.

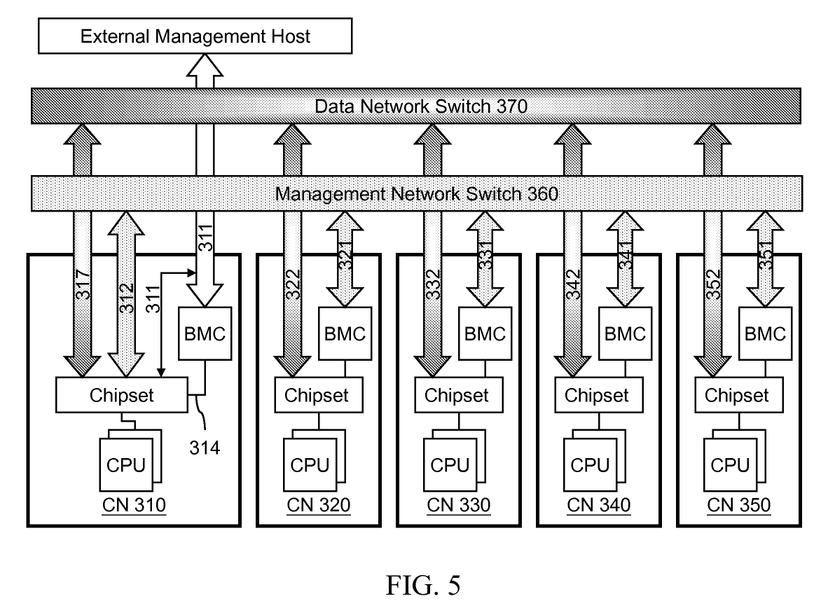

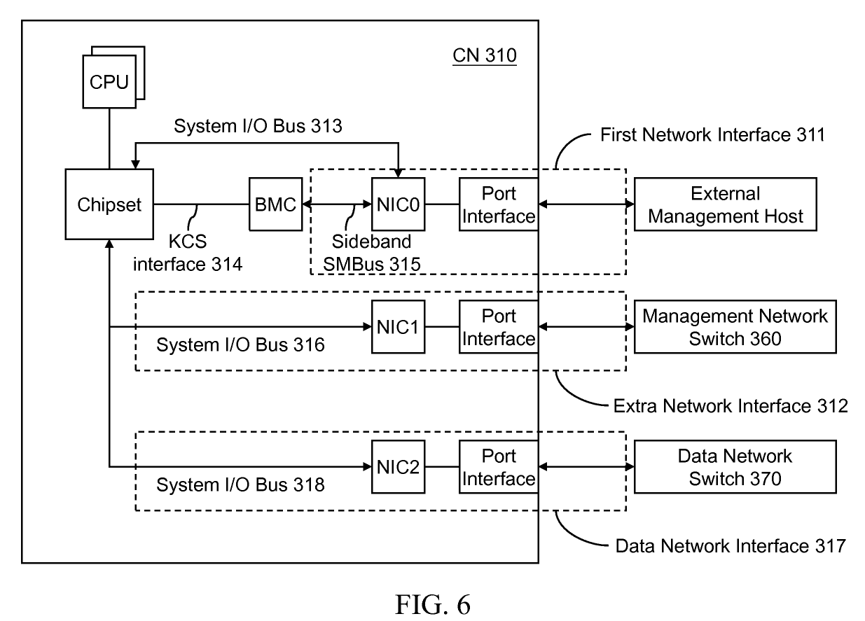

Please refer to FIG. 5. Other internal private network connections may be further provided in the small clustering system. A second network interface 317/322/332/342/352 is provided for each of the compute nodes CN310/320/330/340/350 to connect with the corresponding chipset and a data network switch 370 and form other internal private network connections. The data network switch 370 is used for applications of MPI (Message Passing Interface) or network storage. MPI is usually used for data communication in a typical clustering system. FIG. 6 shows more details for another of applicable designs of the preset compute node CN 310 according to another embodiment of the present invention.

The preset compute node CN 310 now includes three network interface controllers NIC0, NIC1, NIC2 to fulfill all the network functions in the clustering system. Other computer nodes CN320, 330, 340, 350 will have only two network interface controllers. In addition, other network interfaces such as Ethernet, InfiniBand, 10 Giga-bit Ethernet and etc. may also be configured on each of the compute nodes.

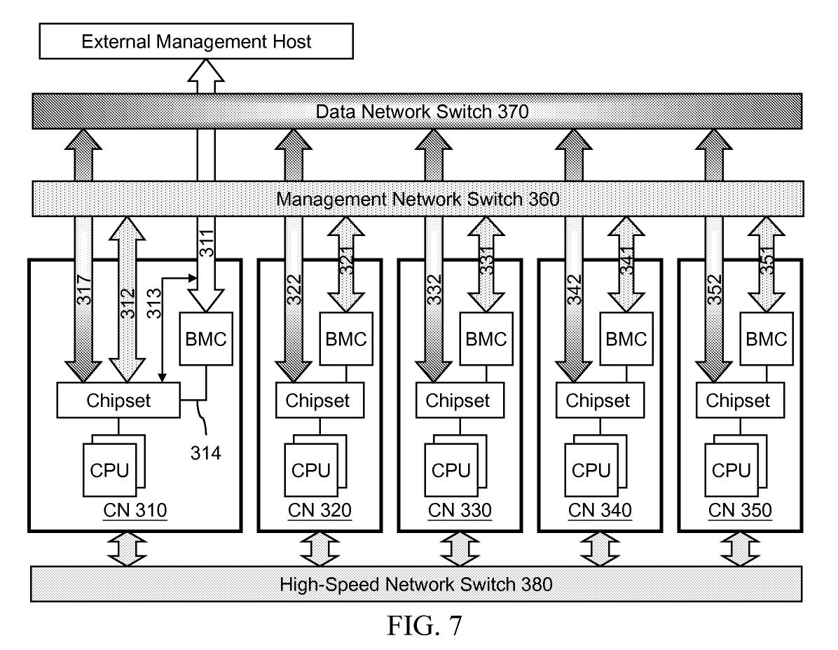

In FIG. 7, the compute nodes CN310, 320, 330, 340, 350 connect with a high-speed network switch 380, a network switch for high-bandwidth network such as 10 Gbit Ethernet or InfiniBand. The high-speed network switch 380 helps to form another internal private network in the clustering system to facilitate high bandwidth communication between the compute nodes CN310, 320, 330, 340, 350. Certainly an additional network interface controller will be necessary for such design; only the network interface controller may be configured on the high-speed network switch 380 or each of the compute nodes CN310, 320, 330, 340, 350 optionally.

In short, the present invention provides chassis-level central management function without any special hardware such as a dedicated service processor module. The present invention uses only common hardware to approach this feature, which is a very cost effective implementation for a small clustering system. Besides, all internal network topology will be completely encapsulated and users do not have to touch internal network structure. For user's viewpoint, this type of implementation is just like a single computer system. Then, users are released from very complicated network setup to make a clustering system. Moreover, the present invention utilizes only common and standard interface for the system management, such as IPMI. Therefore, the development for providing the service processor application is easy. Most of the basic functions are defined in the standard and the actual development is an application level running on a regular OS on the preset compute node, which actually plays the role like a head node. This would be much easier than developing a dedicated service processor using an independent OS, low-level device driver and management application.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system management architecture for managing a plurality of compute nodes of a clustering system, comprising:
a plurality of BMCs (Baseboard Management Controllers) located on the compute nodes respectively for monitoring and controlling the compute nodes remotely; and
a management network switch and a plurality of first network interfaces providing private network connections between the BMCs of the compute nodes;
wherein on a preset one of the compute nodes an extra network interface connects with the management network switch instead of the first network interface and the BMC connects with a external management host through the first network interface.

2. The system management architecture of claim 1, wherein each of the compute nodes comprises a chipset respectively and on the preset one of the compute nodes the chipset connects directly with the first network interface through a system I/O bus, as well as connects indirectly with the first network interface through the BMC.

3. The system management architecture of claim 2, wherein on the preset one of the compute nodes the chipset connects the BMC through a KCS (Keyboard Controller Style) interface.

4. The system management architecture of claim 1, wherein each of the first network interfaces and the extra network interface comprises a network interface controller.

5. The system management architecture of claim 4, wherein on the preset one of the compute nodes the BMC connects with the network interface controller through a sideband SMBus (System Management Bus).

6. The system management architecture of claim 1, wherein on the preset one of the compute nodes a operating system provides Network Address Translation service to allow the external management host to access each of the compute nodes.

7. The system management architecture of claim 1 further comprises a data network switch and on each of the compute nodes a second network interface is provided to connect with the data network switch for applications of MPI (Message Passing Interface) or network storage.

8. The system management architecture of claim 1 further comprises a high-speed network switch connecting with each of the compute nodes to facilitate high bandwidth communication between the compute nodes.

9. The system management architecture of claim 8, wherein an additional network interface controller is configured on either the high-speed network switch or each of the compute nodes.

10. The system management architecture of claim 1, wherein each of the first network interfaces and the extra network interface is compatible with IPMI (Intelligent Platform Management Interface) specification.

11. A clustering system, comprising:
a plurality of compute nodes and a system management architecture for managing the compute nodes, the system management architecture comprising;
a plurality of BMCs (Baseboard Management Controllers) located on the compute nodes respectively for monitoring and controlling the compute nodes remotely; and
a management network switch and a plurality of first network interfaces providing private network connections between the BMCs of the compute nodes;
wherein on a preset one of the compute nodes an extra network interface connects with the management network switch instead of the first network interface and the BMC connects with a external management host through the first network interface.

12. The clustering system of claim 11, wherein each of the compute nodes comprises a chipset respectively and on the preset one of the compute nodes the chipset connects directly with the first network interface through a system I/O bus, as well as connects indirectly with the first network interface through the BMC.

13. The clustering system of claim 12, wherein on the preset one of the compute nodes the chipset connects the BMC through a KCS (Keyboard Controller Style) interface.

14. The clustering system of claim 11, wherein each of the first network interfaces and the extra network interface comprises a network interface controller.

15. The clustering system of claim 14, wherein on the preset one of the compute nodes the BMC connects with the network interface controller through a sideband SMBus.

16. The clustering system of claim 11, wherein on the preset one of the compute nodes a operating system provides Network Address Translation service to allow the external management host to access each of the compute nodes.

17. The clustering system of claim 11 further comprises a data network switch and for each of the compute nodes a second network interface is provided to connect with the data network switch for applications of MPI (Message Passing Interface) or network storage.

18. The clustering system of claim 11 further comprises a high-speed network switch connecting with each of the compute nodes to facilitate high bandwidth communication between the compute nodes.

19. The clustering system of claim 18, wherein an additional network interface controller is configured on either the high-speed network switch or each of the compute nodes.

20. The clustering system of claim 11, wherein each of the first network interfaces and the extra network interface is compatible with IPMI (Intelligent Platform Management Interface) specification.
